(19) United States
(12) Patent Application Publication
(10) Pub. No.: US 2017/0230977 A1
(43) Pub. Date: Aug. 10, 2017

(54) BASE STATION, USER EQUIPMENT AND ASSOCIATED METHODS

(71) Applicant: SHARP KABUSHIKI KAISHA, Sakai City, Osaka (JP)

(72) Inventors: Xingya SHEN, Shanghai (CN); Renmao LIU, Shanghai (CN)

(73) Assignee: SHARP KABUSHIKI KAISHA, Sakai City, Osaka (JP)

(21) Appl. No.: 15/501,562

(22) PCT Filed: Aug. 5, 2015
(86) PCT No.: PCT/CN2015/086104

§ 371 Date: Feb. 3, 2017

(30) Foreign Application Priority Data
Aug. 5, 2014 (CN) 201410381780.9

(51) Int. Cl. H04W 72/04; H04W 4/00

(52) U.S. Cl. CPC H04W 72/0446; H04W 4/005; H04W 72/042; H04W 72/0453

(57) ABSTRACT

The present disclosure provides a method in a base station. The method comprises: determining resources for transmitting system information to a Machine Type Communication (MTC) User Equipment (UE), the system information comprising a System Information Block Type 1 (SIB1) message and other system information messages; and transmitting the system information to the MTC UE over the determined resources, the transmission comprising an initial transmission and one or more retransmissions. The resources for the initial transmission and the one or more retransmissions of the other system information messages are indicated by the SIB1 message or predetermined.

### TECHNICAL FIELD

The present disclosure relates to wireless communication technology, and more particularly, to a base station, a User Equipment (UE) and associated methods.

### BACKGROUND

The Long Term Evolution (LTE) system deployed by the 3^{rd} Generation Partner Project (3GPP) is intended to provide increasingly diversified mobile communication services in the future. Wireless cellular communications have become an essential part of people's lives and work. In the first release (Release 8) of the 3GPP LTE, Orthogonal Frequency Division Multiple Access (OFDMA) and Multiple Input Multiple Output (MIMO) techniques have been introduced. After evaluation and test by International Telecommunication Union (ITU), the 3GPP Release 10 has been established as the 4^{th} generation global mobile communication standard, known as LTE-Advanced. In the LTE-Advanced standard, Carrier Aggregation (CA) and relay techniques have been introduced to improve uplink (UL)/downlink (DL) MIMO technique while supporting heterogeneous network (HetNet) deployment.

In order to meet the market demand on home device communications and the deployment of a huge-scale Internet of Things (loT) in the future, the 3GPP has decided to introduce a low-cost Machine Type Communication (MTC) technique in the LTE and its further evolution, to transfer MTC services from the current GSM network to the LTE network and define several new types of UEs, one of which is referred to as Low-cost MTC UE. Such UE can support MTC services in all duplex modes in the current LTE network and has: 1) one single receiving antenna; 2) a maximum Transport Block Size (TBS) of 1000 bits in UL/DL; 3a) a reduced baseband bandwidth of DL data channel of 1.4 MHz, a bandwidth of DL control channel identical to the system bandwidth of the network layer, and the same UL channel bandwidth and DL Radio Frequency (RF) part as UEs in the current LTE network; and 3b) a reduced baseband bandwidth of DL/UL control/data channel of 1.4 MHz.

The MTC is a data communication service without human involvement. A large-scale deployment of MTC UEs can be applied to various fields such as security, tracking, payment, measurement, consumer electronics, and in particular to applications such as video surveillance, supply chain tracking, intelligent metering and remote monitoring. The MTC UE requires low power consumption and supports low data transmission rate and low mobility. Currently, the LTE system is mainly designed for Human−to-Human (H2H) communication services. Hence, in order to achieve the scale benefit and application prospect of the MTC services, it is important for the LTE network to support the low-cost MTC devices to operate at low cost and low complexity.

Some MTC UEs are mounted in basements of residential buildings or locations protected by insulating films, metal windows or thick walls of traditional buildings. These devices will suffer significantly higher penetration loss in air interface than conventional device terminals, such as mobile phones and tablets, in the LTE network. The 3GGP has started researches on solution designs and performance evaluations for the LTE network to provide the MTC UEs with a 20 dB/15 dB of additional coverage enhancement. It is to be noted that an MTC UE located in an area with poor network coverage has a very low data transmission rate, a very loose delay requirement and a limited mobility. For these MTC UE characteristics, some signaling and/or channels of the LTE network can be further optimized to support the MTC UEs. The 3GPP requires providing the newly defined MTC UEs and other UEs running MTC services (e.g., with very loose delay requirements) with a certain level of LTE network coverage enhancement. In particular, a 15 dB of network coverage enhancement is provided in the LTE Frequency Division Duplex (FDD) network. Additionally, not all UEs running MTC services need the same network coverage enhancement.

For the new MTC UE, in the DL and/or UL, the data and/or control channel is 1.4 MHz (i.e., 6 Resource Blocks (RBs)). In addition, the low-cost MTC UE has one single receiving antenna and its maximum UL transport block and DL transport block are each 1000 bits.

For 3GPP LTE UEs running MTC services in the coverage enhancement mode, the design and configuration of coverage enhancement for physical channels (such as Physical Downlink Control Channel (PDCCH), Physical Downlink Shared Channel (PDSCH), Physical Uplink Control Channel (PUCCH) and Physical Uplink Shared Channel (PUSCH)) need to be standardized. According to the discussions in the 3GPP RAN#74 meeting, after completion of the initial access, the configuration mode of any physical channel that requires repetitive transmission is decided at the base station. In the discussions in the 3GPP RAN1 #85 meeting, for an MTC UE in the coverage enhancement mode, there is no need to introduce new system information for the MTC UE with coverage enhancement. For common information such as system information, in order to meet the coverage enhancement requirement of a UE in the worst condition in a cell, the system information needs the maximum degree of retransmission. However, a delay to 2 to 10 seconds will be introduced for the MTC UE to combine and demodulate a large amount of repeated system information. Such delay will limit flexibility in scheduling system information for non−MTC UEs. According to the decision in the 3GPP RAN1 #74 meeting, transmission of data channel for an MTC UE requiring coverage enhancement shall occur after transmission of control channel has been completed. Hence, there is a need for a new solution to reduce the delay for the UE to obtain the system information.

Accordingly, a new solution is needed for resource allocation in time domain for transmission of system information. In Rel-12 and its successors, a new solution is needed for transmission of system information for an MTC UE in a coverage enhancement mode and/or a low-complexity or low-cost MTC UE.

### SUMMARY

It is an object of the present disclosure to provide a base station, a UE and associated methods, capable of efficiently transmitting system information messages.

In a first aspect of the present disclosure, a method in a base station is provided. The method comprises: determining resources for transmitting system information to a Machine Type Communication (MTC) User Equipment (UE), the system information comprising a System Information Block Type 1 (SIB1) message and other system information messages; and transmitting the system information to the MTC UE over the determined resources, the transmission comprising an initial transmission and one or more retransmissions. The resources for the initial transmission and the one or more retransmissions of the other system information messages are indicated by the SIB1 message or predetermined.

In an embodiment, the SIB1 message comprises a transmission cycle indication indicating a length of a transmission cycle in which the initial transmission and the one or more retransmissions of the other system information messages occur, or the length of the transmission cycle is predetermined.

In an embodiment, the transmission cycle comprises a plurality of system information windows, each of one or more of the plurality of system information windows is used for the initial transmission and the one or more retransmissions of the other system information messages. The SIB1 message further comprises: a time domain resource mapping indication indicating time domain resources in each of the one or more system information windows that are used for the initial transmission and the one or more retransmissions of the other system information messages, and a window repetition indication indicating a position of each of the one or more system information windows in the transmission cycle. Alternatively, at least of the time domain resources in each of the one or more system information windows that are used for the initial transmission and the one or more retransmissions of the other system information messages and the position of each of the one or more system information windows in the transmission cycle is predetermined.

In an embodiment, the transmission of the system information to the MTC UE at least partly reuses resources for transmission of system information to a non−MTC UE.

In an embodiment, the transmission cycle comprises a plurality of combination system information windows each for an initial transmission or retransmission of one or more of the other system information messages. The SIB1 message further comprises: a combination window length indication indicating a length of each combination system information window; a time domain resource mapping indication indicating time domain resources in each combination system information window that are used for the initial transmission or retransmission of the one or more other system information messages, and a repetition number indication indicating a number of combination system information windows included in the transmission cycle. Alternatively, at least one of the length of each combination system information window, the time domain resources in each combination system information window that are used for the initial transmission or retransmission of the one or more other system information messages and the number of combination system information windows included in the transmission cycle is predetermined.

In an embodiment, the transmission of the system information to the MTC UE is independent from transmission of system information to a non−MTC UE.

In an embodiment, the SIB1 message further comprises: at least one of a Modulation and Coding Scheme (MCS) indication and a Transport Block Size (TBS) indication, the MCS indication indicating an MCS for the initial transmission and the one or more retransmissions of the other system information messages, and the TBS indication indicating a TBS for the initial transmission and the one or more retransmissions of the other system information messages, and a frequency domain indication indicating frequency domain resources for the initial transmission and the one or more retransmissions of the other system information messages. Alternatively, at least one of the MCS for the initial transmission and the one or more retransmissions of the other system information messages, the TBS for the initial transmission and the one or more retransmissions of the other system information messages and the frequency domain resources for the initial transmission and the one or more retransmissions of the other system information messages is predetermined.

In a second aspect of the present disclosure, a base station is provided. The base station comprises: a resource determining unit configured to determine resources for transmitting system information to a Machine Type Communication (MTC) User Equipment (UE), the system information comprising a System Information Block Type 1 (SIB1) message and other system information messages; and a transmitting unit configured to transmit the system information to the MTC UE over the determined resources, the transmission comprising an initial transmission and one or more retransmissions. The resources for the initial transmission and the one or more retransmissions of the other system information messages are indicated by the SIB1 message or predetermined.

The embodiments of the method in the above first aspect also apply to the base station.

In a third aspect of the present disclosure, a method in a Machine Type Communication (MTC) User Equipment (UE) is provided. The method comprise: receiving a System Information Block Type 1 (SIB1) message from a base station; determining resources for use by the base station for transmitting other system information messages, the transmission comprising an initial transmission and one or more retransmissions; and receiving the other system information messages over the determined resources. The resources for the initial transmission and the one or more retransmissions of the other system information messages are indicated by the SIB1 message or predetermined.

In an embodiment, the SIB1 message comprises a transmission cycle indication indicating a length of a transmission cycle in which the initial transmission and the one or more retransmissions of the other system information messages occur, or the length of the transmission cycle is predetermined.

In an embodiment, the transmission cycle comprises a plurality of system information windows, each of one or more of the plurality of system information windows is used for the initial transmission and the one or more retransmissions of the other system information messages. The SIB1 message further comprises: a time domain resource mapping indication indicating time domain resources in each of the one or more system information windows that are used for the initial transmission and the one or more retransmissions of the other system information messages, and a window repetition indication indicating a position of each of the one or more system information windows in the transmission cycle. Alternatively, at least of the time domain resources in each of the one or more system information windows that are used for the initial transmission and the one or more retransmissions of the other system information messages and the position of each of the one or more system information windows in the transmission cycle is predetermined.

In an embodiment, the transmission of the system information to the MTC UE at least partly reuses resources for transmission of system information to a non−MTC UE.

In an embodiment, the step of determining resources for use by the base station for transmitting the other system information messages comprises: determining a radio frame number, SFN, and a start subframe number, a, for use by the base station for transmitting the other system information messages, such that:

a=x mode 10,

where x=(n−1)*w, where n denotes an order of the other system information messages in a list of the system information messages, and w denotes a length of each system information window;

SFN mod M=floor (x/10),

where M denotes a length of the transmission cycle and floor( ) denotes a flooring function. The step of receiving the other system information messages over the determined resources comprises: receiving the other system information messages in accordance with the determined radio frame number, SFN, and start subframe number, a, and the time domain resources in each of the one or more system information windows that are used for the initial transmission and the one or more retransmissions of the other system information messages, until the other system information messages have been correctly received or all of the system information windows have been received.

In an embodiment, the transmission cycle comprises a plurality of combination system information windows each for an initial transmission or retransmission of one or more of the other system information messages. The SIB1 message further comprises: a combination window length indication indicating a length of each combination system information window; a time domain resource mapping indication indicating time domain resources in each combination system information window that are used for the initial transmission or retransmission of the one or more other system information messages, and a repetition number indication indicating a number of combination system information windows included in the transmission cycle. Alternatively, at least one of the length of each combination system information window, the time domain resources in each combination system information window that are used for the initial transmission or retransmission of the one or more other system information messages and the number of combination system information windows included in the transmission cycle is predetermined.

In an embodiment, the transmission of the system information to the MTC UE is independent from transmission of system information to a non−MTC UE.

In an embodiment, the step of determining resources for use by the base station for transmitting the other system information messages comprises: determining a radio frame number, SFN, and a start subframe number, b, for use by the base station for transmitting the plurality of combination system information windows, such that:

b=0,

SFN mod M=0,

where M denotes a length of the transmission cycle. The step of receiving the other system information messages over the determined resources comprises: receiving the other system information messages in accordance with the determined radio frame number, SFN, and start subframe number, b, and the time domain resources in each combination system information window that are used for the initial transmission or retransmission of the one or more other system information messages, until the other system information messages have been correctly received or all of the combination system information windows have been received.

In an embodiment, the SIB1 message further comprises: at least one of a Modulation and Coding Scheme (MCS) indication and a Transport Block Size (TBS) indication, the MCS indication indicating an MCS for the initial transmission and the one or more retransmissions of the other system information messages, and the TBS indication indicating a TBS for the initial transmission and the one or more retransmissions of the other system information messages, and a frequency domain indication indicating frequency domain resources for the initial transmission and the one or more retransmissions of the other system information messages. Alternatively, at least one of the MCS for the initial transmission and the one or more retransmissions of the other system information messages, the TBS for the initial transmission and the one or more retransmissions of the other system information messages and the frequency domain resources for the initial transmission and the one or more retransmissions of the other system information messages is predetermined.

In a fourth aspect of the present disclosure, a Machine Type Communication (MTC) User Equipment (UE) is provided. The MTC UE comprises: a receiving unit configured to receive a System Information Block Type 1 (SIB1) message from a base station; and a determining unit configured to determine resources for use by the base station for transmitting other system information messages, the transmission comprising an initial transmission and one or more retransmissions. The receiving unit is further configured to receive the other system information messages over the determined resources. The resources for the initial transmission and the one or more retransmissions of the other system information messages are indicated by the SIB1 message or predetermined.

The embodiments of the method in the above third aspect also apply to the MTC UE.

With the embodiments of the present disclosure, transmission of system information to an MTC UE requiring coverage enhancement needs no control channel. On the hand, since an SIB1 message contains scheduling information for other system information messages, the scheduling information in the SIB1 and newly added scheduling information can be used to schedule the other system information messages. On the other hand, transmission resources for the other system information messages can be predetermined.

### BRIEF DESCRIPTION OF THE DRAWINGS

The above and other objects, features and advantages will be more apparent from the following description of embodiments with reference to the figures, in which:

FIG. 1 is a block diagram of a base station according to an embodiment of the present disclosure;

FIG. 2 is a schematic diagram showing transmission of an SIB1 message;

FIG. 3 is a schematic diagram showing transmission of other system information messages according to an embodiment of the present disclosure;

FIG. 4 is a schematic diagram showing transmission of other system information messages according to another embodiment of the present disclosure;

FIG. 5 is a flowchart illustrating a method in a base station according to an embodiment of the present disclosure;

FIG. 6 is a block diagram of a UE according to an embodiment of the present disclosure;

FIG. 7 is a flowchart illustrating a method in a UE according to an embodiment of the present disclosure; and

FIG. 8 is a schematic diagram showing transmission of other system information messages according to another embodiment of the present disclosure.

### DETAILED DESCRIPTION

The principles and implementations of the present disclosure will become more apparent with reference to the following description of the embodiments taken in conjunction with the figures. It should be noted that the following embodiments are illustrative only, rather than limiting the scope of the present disclosure. In the following description, details of well known techniques which are not directly relevant to the present invention will be omitted so as not to obscure the concept of the invention.

In the following, a number of embodiments of the present invention will be detailed in an exemplary application environment of LTE mobile communication system and its subsequent evolutions. Herein, it is to be noted that the present invention is not limited to the application exemplified in the embodiments. Rather, it is applicable to other communication systems, such as the future 5G cellular communication system.

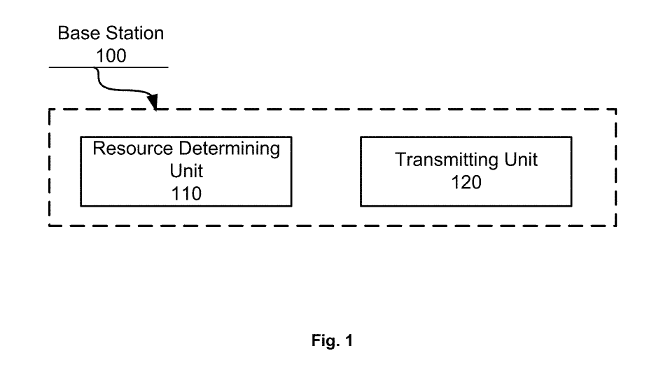

FIG. 1 is a block diagram of a base station 100 according to an embodiment of the present disclosure. As shown, the base station 100 includes a resource determining unit 110 and a transmitting unit 120. It can be appreciated by those skilled in the art that the base station 100 further includes other functional unit necessary for its functions, such as various processors and memories.

The resource determining unit 110 is configured to determine resources for transmitting system information to a Machine Type Communication (MTC) User Equipment (UE). The system information comprises a System Information Block Type 1 (SIB1) message and other system information messages (e.g., SIB2, SIB3, SIB4 and the like).

The transmitting unit 120 is configured to transmit the system information to the MTC UE over the determined resources. The transmission includes an initial transmission and one or more retransmissions.

According to the present disclosure, the resources for the initial transmission and the one or more retransmissions of the other system information messages are indicated by the SIB1 message or predetermined.

For a non−MTC UE, the SIB1 message has a fixed scheduling in time domain and has a period of 80 ms. In particular, the initial transmission of the SIB1 message occurs in the fifth subframe of some radio frames each having a radio frame number (SFN) satisfying SFN mod 8=0. The retransmissions of the SIB1 message occur in the fifth subframe of some radio frames each having an SFN satisfying SFN mod 2=0.

For an MTC UE requiring coverage enhancement, the SIB1 message needs retransmissions in time domain. Hence, the SIB1 message for the MTC UE may reuse the SIB1 message for the non−MTC UE. The additional retransmissions of the SIB1 message for the MTC UE can be predefined in the time domain, or can be fixed in e.g., the fourth subframe and/or the ninth subframe. In the context of the present disclosure, the “additional retransmissions” refer to retransmissions for the purpose of coverage enhancement (i.e., for an MTC UE).

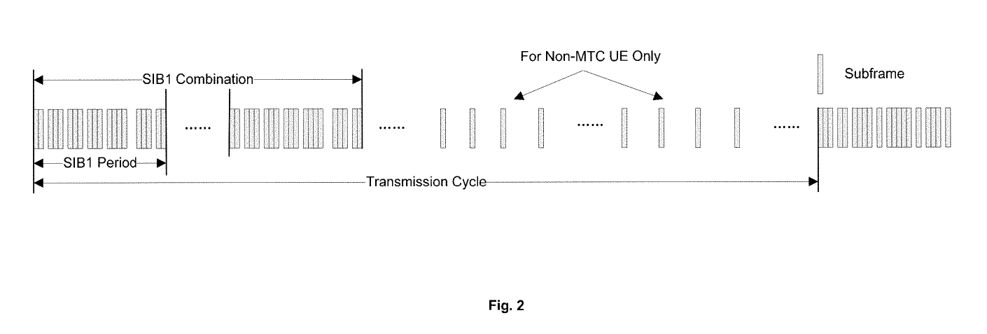

FIG. 2 shows retransmissions of an SIB1 message. As shown in FIG. 2, the SIB message can be retransmitted intermittently within one transmission cycle (or modification period) for an MTC UE. The pattern of the intermittent retransmissions can be predefined or fixed.

In an embodiment, the positions of SIB1 message transmissions for the MTC UE requiring coverage enhancement in frequency domain do not need to be indicated in a control channel. Hence, the positions of the SIB1 message in frequency domain can be predefined or fixed. In order to achieve a diversity gain, an inter-subframe frequency hopping can be adopted for the SIB1 message. The frequency hopping scheme of such inter-subframe frequency hopping depends on system frame number and/or subframe and/or timeslot.

In an embodiment, the transmission format of the SIB1 message for the MTC UE requiring coverage enhancement in frequency domain does not need to be indicated in a control channel. Hence, the Modulation and Coding Scheme (MCS) of the SIB1 message can be predefined or fixed. For details of MCSs, reference can be made to Rel-8/10 standards.

Alternatively, the TBS of the SIB1 message can be predefined or fixed. For details of TBSs, reference can be made to Rel-8/10 standards.

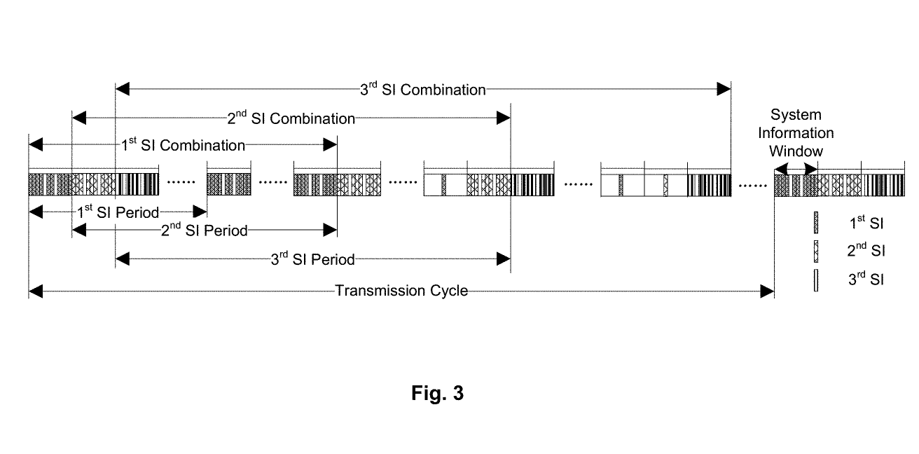

FIG. 3 is a schematic diagram showing transmission of other System Information (SI) messages. In the example shown in FIG. 3, for an MTC UE, the initial transmission and the one or more retransmissions of the other system information messages occur in a transmission cycle. The transmission cycle includes a plurality of system information windows. Each of one or more of the plurality of system information windows is used for the initial transmission and the one or more retransmissions of the other system information messages. FIG. 3 shows transmission periods of first SI, second SI and third SI, respectively. It can be seen that this transmission scheme allow the MTC UE to combine the transmissions of the SI messages in the plurality of system information windows. As shown in FIG. 3, additional retransmissions of the system information occur in some of the system information windows, but do not occur in the other system information windows which are used for a non−MTC UE. The transmission cycle defines a cycle in which the MTC UE can obtain all the relevant system information messages.

In an embodiment, the SIB1 message includes a transmission cycle indication indicating a length of a transmission cycle in which the initial transmission and the one or more retransmissions of the other system information messages occur. Alternatively, the length of the transmission cycle is predetermined.

In an embodiment, the transmission of the system information to the MTC UE at least partly reuses resources for transmission of system information to a non−MTC UE.

The transmission cycle includes a plurality of system information windows. Each of one or more of the plurality of system information windows is used for the initial transmission and the one or more retransmissions of the other system information messages. The SIB1 message further includes: a time domain resource mapping indication indicating time domain resources in each of the one or more system information windows that are used for the initial transmission and the one or more retransmissions of the other system information messages, and a window repetition indication indicating a position of each of the one or more system information windows in the transmission cycle.

Alternatively, at least of the time domain resources in each of the one or more system information windows that are used for the initial transmission and the one or more retransmissions of the other system information messages and the position of each of the one or more system information windows in the transmission cycle is predetermined.

In particular, if the length of each system information window is e.g., 5 ms, the transmission of the system information may occur in a predefined subset, X, of subframes within the system information window, where X={{1}, {2}, . . . , {5}, {1,2}, . . . , {4,5}, . . . , {1,2,3,4,5}}.

Alternatively, the time domain resource mapping indication can be used. The time domain resource mapping indication can indicate a pattern of repeated transmissions of the system information within the system information window in time domain. For example, this indication can be a parameter si-timedomainresourcemapping, which is dependent on the length of the system information window. It is a bitmap having a length equal to the length of the system information window, for indicating on which subframes the system information is transmitted (including the initial transmission and the retransmissions). For example, a “0” indicates that its corresponding subframe is used for transmission, while a “1” indicates that its corresponding subframe is not used for transmission. An exemplary format of SIB1 is given in Table 1-1 below.

TABLE 1-1
SystemInformationBlockType1

SchedulingInfoList ::= SEQUENCE (SIZE (1...maxSI-Message)) OF SchedulingInfo
SchedulingInfo ::= SEQUENCE {

| | |
|---|---|
| si-Periodicity | ENUMERATED { |

rf8, rf16, rf32, rf64, rf128, rf256, rf512},

| | |
|---|---|
| sib-MappingInfo | SIB-MappingInfo |

| | |
|---|---|
| si-timedomainresourcemapping | SEQUENCE (SIZE (si-WindowLength)), |

}
SIB-MappingInfo ::= SEQUENCE (SIZE (0...maxSIB-1)) OF SIB-Type

| | |
|---|---|
| SIB-Type ::= | ENUMERATED { |

sibType3, sibType4, sibType5, sibType6,
sibType7, sibType8, sibType9, sibType10,
sibType11, sibType12-v920, sibType13-v920,
sibType14-v1130, sibType15-v1130,
sibType16-v1130, spare2, spare1, ...}

The time domain resource mapping indication can be cell specific, i.e., the system information for all MTC UEs within a cell shares the same time domain resource mapping indication, as shown in Table 1-1. Alternatively, the time domain resource mapping indication can be SI specific, i.e., the time domain resource mapping indication is different for different system information for the MTC UE, as shown in Table 1-2.

TABLE 1-2
SystemInformationBlockType1

SchedulingInfoList ::= SEQUENCE (SIZE (1...maxSI-Message)) OF SchedulingInfo
SchedulingInfo ::= SEQUENCE {

| | |
|---|---|
| si-Periodicity | ENUMERATED { |

rf8, rf16, rf32, rf64, rf128, rf256, rf512},

| | |
|---|---|
| sib-MappingInfo | SIB-MappingInfo |

| | |
|---|---|
| si-timedomainresourcemappingS11 | SEQUENCE (SIZE (si-WindowLength)), |

.
.
.

| | |
|---|---|
| si-timedomainresourcemappingS13 | SEQUENCE (SIZE (si-WindowLength)) |

.
.
.
}
SIB-MappingInfo ::= SEQUENCE (SIZE (0...maxSIB-1)) OF SIB-Type

| | |
|---|---|
| SIB-Type ::= | ENUMERATED { |

sibType3. sibType4, sibType5, sibType6,
sibType7, sibType8, sibType9, sibType10,
sibType11, sibType12-v920, sibType13-v920,
sibType14-v1130, sibType15-v1130,
sibType16-v1130, spare2, spare1, ...}

In Table 1-2, the time domain resource mapping indication can be a parameter si-timedomainresourcemappingSlx, where Slx denotes the x-th system information. This parameter is dependent on the length of the system information window. It is a bitmap having a length equal to the length of the system information window, for indicating on which subframes the system information is transmitted (including the initial transmission and the retransmissions). For example, a “0” indicates that its corresponding subframe is used for transmission, while a “1” indicates that its corresponding subframe is not used for transmission.

In an embodiment, not all of the system information windows within one transmission cycle require additional retransmissions. For example, it can be predefined that the first K system information windows within one transmission cycle require additional retransmissions, where K is a natural number.

Alternatively, the window repetition indication can be used. The window repetition indication can indicate which of the system information windows require(s) additional retransmissions. The window repetition indication can be a si-repetitionsiwindow, where “n1” represents that the first one system information window requires additional retransmission, “n2” represents that the first two system information windows require additional retransmissions, and so on. An exemplary format of SIB1 is given in Table 1-3 below.

TABLE 1-3
SystemInformationBlockType1

SchedulingInfoList ::= SEQUENCE (SIZE (1...maxSI-Message)) OF SchedulingInfo
SchedulingInfo ::= SEQUENCE {

| | |
|---|---|
| si-Periodicity | ENUMERATED { |

rf8, rf16, rf32. rf64, rf128, rf256, rf512},

| | |
|---|---|
| sib-MappingInfo | SIB-MappingInfo |

| | |
|---|---|
| si-repetitionsiwindow | INTEGER {n1, n2, n3, n4, n5, n6} |

}
SIB-MappingInfo ::= SEQUENCE (SIZE (0...maxSIB-1)) OF SIB-Type

| | |
|---|---|
| SIB-Type ::= | ENUMERATED { |

sibType3, sibType4, sibType5, sibType6,
sibType7, sibType8, sibType9, sibType10,
sibType11, sibType12-v920, sibType13-v920,
sibType14-v1130, sibType15-v1130,
sibType16-v1130, spare2, spare1, ...}

In an embodiment, the SIB1 message further includes at least one of a Modulation and Coding Scheme (MCS) indication and a Transport Block Size (TBS) indication, the MCS indication indicating an MCS for the initial transmission and the one or more retransmissions of the other system information messages, and the TBS indication indicating a TBS for the initial transmission and the one or more retransmissions of the other system information messages, and a frequency domain indication indicating frequency domain resources for the initial transmission and the one or more retransmissions of the other system information messages.

Alternatively, at least one of the MCS for the initial transmission and the one or more retransmissions of the other system information messages, the TBS for the initial transmission and the one or more retransmissions of the other system information messages and the frequency domain resources for the initial transmission and the one or more retransmissions of the other system information messages is predetermined.

In particular, for example, the MCS and/or TBS can be predefined and/or fixed. For example, the MCS can be predefined in TS 36.111. The TBS can be fixed at x bit, where x is a natural number. The resource allocation in time domain and/or frequency domain can be predefined and/or fixed. For example, the system information can be transmitted over some subframes in time domain in accordance with a particular pattern. The system information can be transmitted over the entire frequency band in frequency domain in accordance with a particular pattern. The number of repeated transmissions can be predefined and/or fixed, to satisfy the requirement of the UE having the worst channel condition within the coverage of the cell. The transmission cycle can be predetermined and/or fixed.

Alternatively, all of the above parameters can be included in the SIB1. A particular format of the SIB1 is shown in Table 1-4 below.

TABLE 1-4
SystemInformationBlockType1

SchedulingInfoList ::= SEQUENCE (SIZE (1...maxSI-Message)) OF SchedulingInfo
SchedulingInfo ::= SEQUENCE {

| | |
|---|---|
| si-Periodicity | ENUMERATED { |

rf8, rf16, rf32, rf64, rf128, rf256, rf512},

| | |
|---|---|
| sib-MappingInfo | SIB-MappingInfo |

| | |
|---|---|
| MCS | SEQUENCE (5) |

| | |
|---|---|
| si-transmissioncycle | ENUMERATED {rf64, rf128, rf256, rf512, rf1024}, |
| si-timedomainresourcemapping | SEQUENCE (SIZE (si-WindowLength)), |

| | |
|---|---|
| si-repetitionwindows | INTEGER {n1, n2, n3, n4, n5, n6} |
| } | |

SIB-MappingInfo ::= SEQUENCE (SIZE (0...maxSIB-1)) OF SIB-Type

| | |
|---|---|
| SIB-Type ::= | ENUMERATED { |

```
  sibType3, sibType4, sibType5, sibType6,
  sibType7, sibType8, sibType9, sibType10,
  sibType11, sibType12-v920, sibType13-v920,
  sibType14-v1130, sibType15-v1130,
  sibType16-v1130, spare2, spare1, ...}
```

In Table 1-4, MCS represents Modulation and Coding Scheme, and si-transmissioncycle represents the length of the transmission cycle, e.g., rf64 denotes 64 radio frames, rf128 denotes 128 radio frames, and so on.

In another alternative embodiment, the transmission of the system information to the MTC UE is independent from transmission of system information to a non−MTC UE.

The transmission cycle includes a plurality of combination system information windows each for an initial transmission or retransmission of one or more of the other system information messages. The SIB1 message further includes: a combination window length indication indicating a length of each combination system information window; a time domain resource mapping indication indicating time domain resources in each combination system information window that are used for the initial transmission or retransmission of the one or more other system information messages, and a repetition number indication indicating a number of combination system information windows included in the transmission cycle.

Alternatively, at least one of the length of each combination system information window, the time domain resources in each combination system information window that are used for the initial transmission or retransmission of the one or more other system information messages and the number of combination system information windows included in the transmission cycle is predetermined.

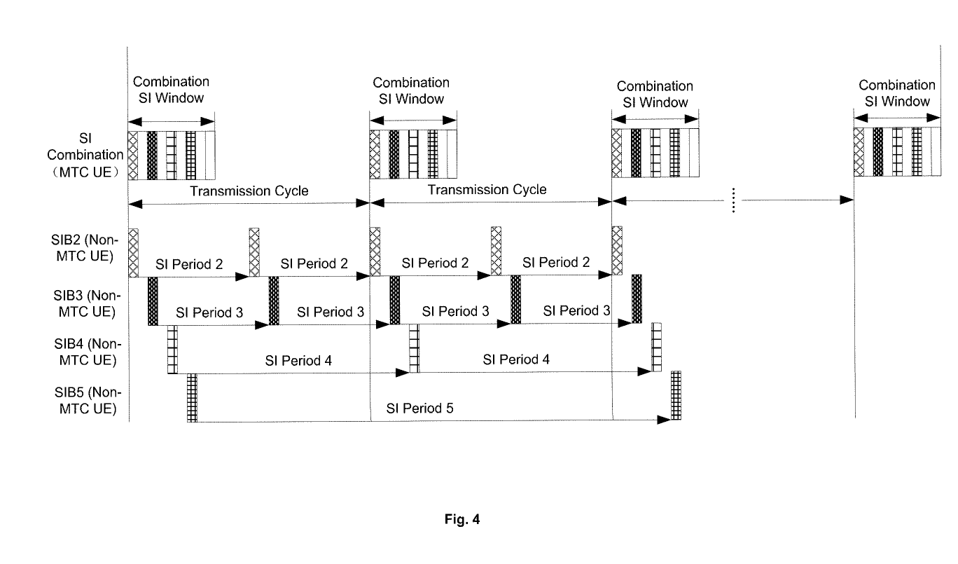

In particular, as shown in FIG. 4, the MTC UE can use combination system information windows for joint transmission of one or more system information windows, while the non−MTC UE uses conventional SI periods.

In an embodiment, a particular format of the SIB1 is shown in Table 2-1 below.

TABLE 2-1
SystemInformationBlockType1

SchedulingInfoList ::= SEQUENCE (SIZE (1...maxSI-Message)) OF SchedulingInfo
SchedulingInfo ::= SEQUENCE {

| | |
|---|---|
| si-Periodicity | ENUMERATED { |

rf8, rf16, rf32, rf64, rf128, rf256, rf512},

| | |
|---|---|
| sib-MappingInfo | SIB-MappingInfo |

| | |
|---|---|
| MCS | SEQUENCE (5) |
| si-WindowLengthCombination | ENUMERATED {ms1, ms2, ms5, ms10, ms15, ms20, |

ms40, ms80},

| | |
|---|---|
| si-transmissioncycle | ENUMERATED {rf64, rf128, rf256, rf512, rf1024}, |

| | |
|---|---|
| si-timedomainresourcemapping | SEQUENCE (SIZE (si-WindowLength)), |

| | |
|---|---|
| repetitiontimes | INTEGER {20, 40, 80, 120} |

}
SIB-MappingInfo ::= SEQUENCE (SIZE (0...maxSIB-1)) OF SIB-Type

| | |
|---|---|
| SIB-Type ::= | ENUMERATED { |

sibType3, sibType4, sibType5, sibType6,
sibType7, sibType8, sibType9, sibType10,
sibType11, sibType12-v920, sibType13-v920,
sibType14-v1130, sibType15-v1130,
sibType16-v1130, spare2, spare1, ...}

Here, the combination window length indication can be a parameter si-WindowLengthCombination, in units of ms; the time domain resource mapping indication can be a parameter si-timedomainresourcemapping, which can be a bitmap as described above, or a parameter si-timedomainresourcemappingSlx, which can be a bitmap as described above; the repetition number indication can be a parameter repetitiontimes. Further, MCS represents Modulation and Coding Scheme, and si-transmissioncycle represents the length of the transmission cycle, as described in Table 1-4 above.

In another alternative embodiment, the transmission of the other system information (SI) to the MTC UE may reuse the transmission of SI to the non−MTC UE.

In time domain, the initial transmission and/or one or more retransmissions of the other SI messages to the MTC UE may be predetermined, fixed, or indicated via the SIB1 message. For example, they can be fixed at the fourth subframe and/or the ninth subframe. In the context of the present disclosure, the “additional retransmissions” refer to retransmissions for the purpose of coverage enhancement (i.e., for an MTC UE).

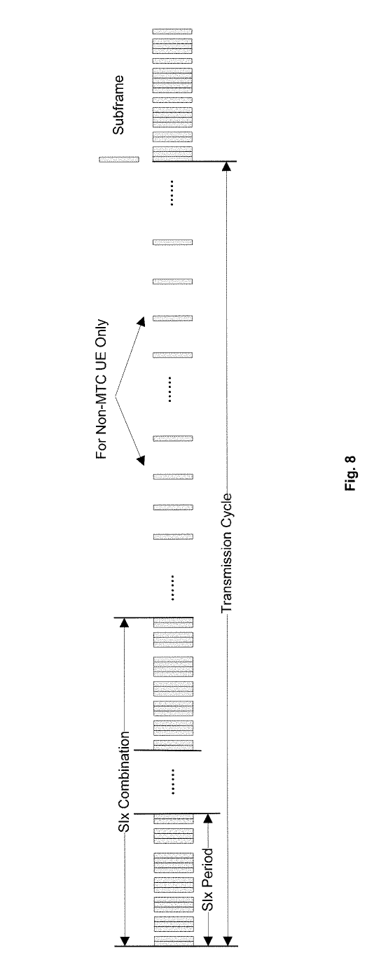

FIG. 8 shows an initial transmission and/or one or more retransmissions of the other SI messages. Here the initial transmission and/or one or more retransmissions of the SI messages may not occur in a system information window. As shown in FIG. 8, the SI messages can be retransmitted intermittently within one transmission cycle (or modification period) for an MTC UE. The pattern of the intermittent retransmissions can be predefined or fixed or indicated via the SIB1 message.

In an embodiment, the positions of SI message transmissions for the MTC UE requiring coverage enhancement in frequency domain do not need to be indicated in a control channel. Hence, the positions of the SI messages in frequency domain can be predefined or fixed or indicated via the SIB1 message. In order to achieve a diversity gain, an inter-subframe frequency hopping can be adopted for the SI messages. The frequency hopping scheme of such inter-subframe frequency hopping depends on system frame number and/or subframe and/or timeslot.

In an embodiment, the transmission formats of the SI messages for the MTC UE requiring coverage enhancement in frequency domain do not need to be indicated in a control channel. Hence, the Modulation and Coding Scheme (MCS) of the SIB1 message can be predefined or fixed or indicated via the SIB1 message. For details of MCSs, reference can be made to Rel-8/10 standards.

Alternatively, the TBSs of the SI messages can be predefined or fixed or indicated via the SIB1 message. For details of TBSs, reference can be made to Rel-8/10 standards.

In an embodiment, a particular format of the SIB1 is shown in Table 3-1 below.

TABLE 3-1
SystemInformationBlockType1

SchedulingInfoList ::= SEQUENCE (SIZE (1...maxSI-Message)) OF SchedulingInfo
SchedulingInfo ::= SEQUENCE {

| | |
|---|---|
| si-Periodicity | ENUMERATED { |

rf8, rf16, rf32, rf64, rf128, rf256, rf512},

| | |
|---|---|
| sib-MappingInfo | SIB-MappingInfo |

| | |
|---|---|
| MCS | SEQUENCE (5) |

| | |
|---|---|
| si-transmissioncycle | ENUMERATED {rf64, rf128, rf256, rf512, rf1024}, |
| repetitiontimes | INTEGER {20, 40, 80, 120}, |

| | |
|---|---|
| si-timedomainresourcemapping | SEQUENCE (SIZE (repetitiontimes)) |

}
SIB-MappingInfo ::= SEQUENCE (SIZE (0...maxSIB-1)) OF SIB-Type

| | |
|---|---|
| SIB-Type ::= | ENUMERATED { |

sibType3, sibType4, sibType5, sibType6,
sibType7, sibType8, sibType9, sibType10,
sibType11, sibType12-v920, sibType13-v920,
sibType14-v1130, sibType15-v1130,

sibType16-v1130, spare2, spare1, ...}

In Table 3-1, the time domain resource mapping indication can be a parameter si-timedomainresourcemapping, which can be a bitmap as described above, or a parameter si-timedomainresourcemappingSlx, which can be a bitmap as described above; and the repetition number indication can be a parameter repetitiontimes. Further, MCS represents Modulation and Coding Scheme, and si-transmissioncycle represents the length of the transmission cycle, as described in Table 1-4 above.

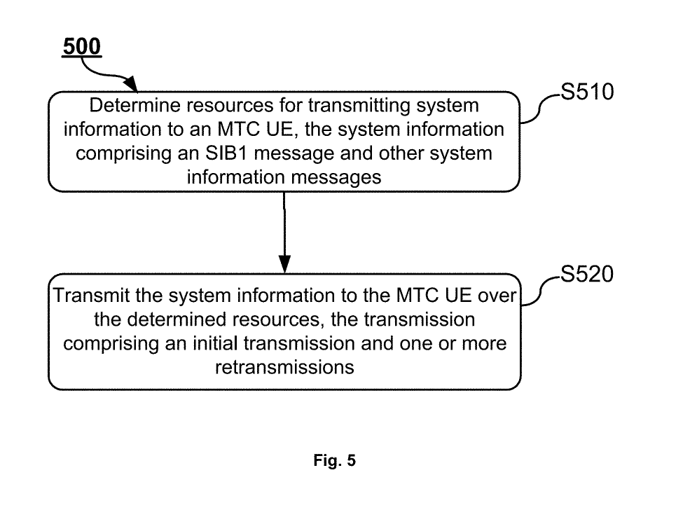

FIG. 5 is a flowchart illustrating a method 500 in a base station according to an embodiment of the present disclosure. It is to be noted here that all the features described above in connection with the embodiments of the base station 100 also apply to the method embodiments below. The method 500 can be performed by the above base station 100 and includes the following steps.

At step S510, resources for transmitting system information to a Machine Type Communication (MTC) User Equipment (UE) are determined. The system information includes a System Information Block Type 1 (SIB1) message and other system information messages.

At step S520, the system information is transmitted to the MTC UE over the determined resources. The transmission includes an initial transmission and one or more retransmissions.

According to the present disclosure, the resources for the initial transmission and the one or more retransmissions of the other system information messages are indicated by the SIB1 message or predetermined.

In an embodiment, the SIB1 message includes a transmission cycle indication indicating a length of a transmission cycle in which the initial transmission and the one or more retransmissions of the other system information messages occur. Alternatively, the length of the transmission cycle is predetermined.

In an embodiment, the transmission cycle includes a plurality of system information windows, each of one or more of the plurality of system information windows is used for the initial transmission and the one or more retransmissions of the other system information messages. The SIB1 message further includes: a time domain resource mapping indication indicating time domain resources in each of the one or more system information windows that are used for the initial transmission and the one or more retransmissions of the other system information messages, and a window repetition indication indicating a position of each of the one or more system information windows in the transmission cycle. Alternatively, at least of the time domain resources in each of the one or more system information windows that are used for the initial transmission and the one or more retransmissions of the other system information messages and the position of each of the one or more system information windows in the transmission cycle is predetermined.

In an embodiment, the transmission of the system information to the MTC UE at least partly reuses resources for transmission of system information to a non−MTC UE.

In an embodiment, the transmission cycle includes a plurality of combination system information windows each for an initial transmission or retransmission of one or more of the other system information messages. The SIB1 message further includes: a combination window length indication indicating a length of each combination system information window; a time domain resource mapping indication indicating time domain resources in each combination system information window that are used for the initial transmission or retransmission of the one or more other system information messages, and a repetition number indication indicating a number of combination system information windows included in the transmission cycle. Alternatively, at least one of the length of each combination system information window, the time domain resources in each combination system information window that are used for the initial transmission or retransmission of the one or more other system information messages and the number of combination system information windows included in the transmission cycle is predetermined.

In an embodiment, the transmission of the system information to the MTC UE is independent from transmission of system information to a non−MTC UE.

In an embodiment, the SIB1 message further includes: at least one of a Modulation and Coding Scheme (MCS) indication and a Transport Block Size (TBS) indication, the MCS indication indicating an MCS for the initial transmission and the one or more retransmissions of the other system information messages, and the TBS indication indicating a TBS for the initial transmission and the one or more retransmissions of the other system information messages, and a frequency domain indication indicating frequency domain resources for the initial transmission and the one or more retransmissions of the other system information messages. Alternatively, at least one of the MCS for the initial transmission and the one or more retransmissions of the other system information messages, the TBS for the initial transmission and the one or more retransmissions of the other system information messages and the frequency domain resources for the initial transmission and the one or more retransmissions of the other system information messages is predetermined.

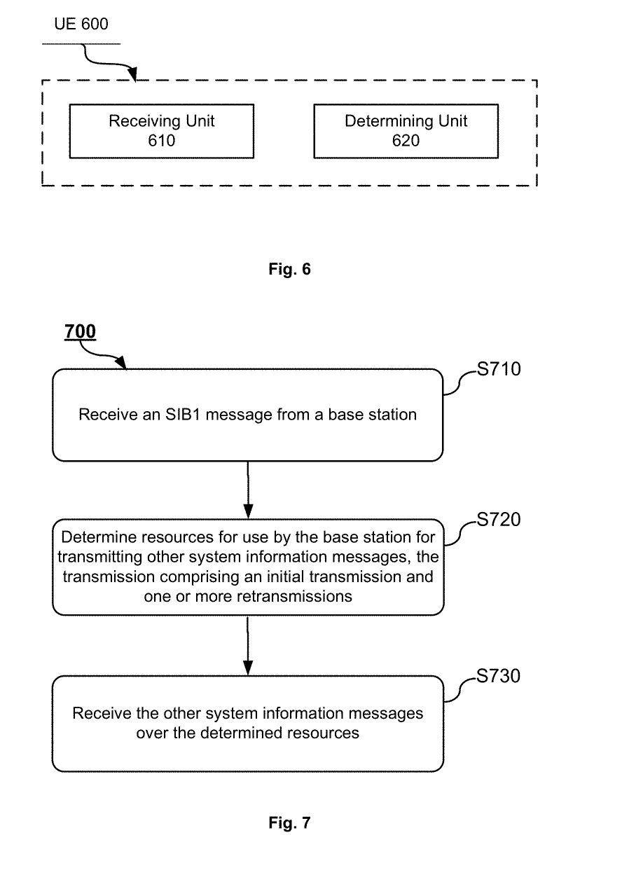

FIG. 6 is a block diagram of an MTC UE 600 according to an embodiment of the present disclosure. As shown, the MTC UE 600 includes a receiving unit 610 and a determining unit 620. It can be appreciated by those skilled in the art that the MTC UE 600 further includes other functional unit necessary for its functions, such as various processors and memories.

The receiving unit 610 is configured to receive a System Information Block Type 1 (SIB1) message from a base station.

The determining unit 620 is configured to determine resources for use by the base station for transmitting other system information messages. The transmission includes an initial transmission and one or more retransmissions.

The receiving unit 610 is further configured to receive the other system information messages over the determined resources.

According to the present disclosure, the resources for the initial transmission and the one or more retransmissions of the other system information messages are indicated by the SIB1 message or predetermined.

In an embodiment, the SIB1 message includes a transmission cycle indication indicating a length of a transmission cycle in which the initial transmission and the one or more retransmissions of the other system information messages occur. Alternatively, the length of the transmission cycle is predetermined.

In an embodiment, the transmission cycle includes a plurality of system information windows, each of one or more of the plurality of system information windows is used for the initial transmission and the one or more retransmissions of the other system information messages. The SIB1 message further includes: a time domain resource mapping indication indicating time domain resources in each of the one or more system information windows that are used for the initial transmission and the one or more retransmissions of the other system information messages, and a window repetition indication indicating a position of each of the one or more system information windows in the transmission cycle. Alternatively, at least of the time domain resources in each of the one or more system information windows that are used for the initial transmission and the one or more retransmissions of the other system information messages and the position of each of the one or more system information windows in the transmission cycle is predetermined.

In an embodiment, the transmission of the system information to the MTC UE at least partly reuses resources for transmission of system information to a non−MTC UE.

In an embodiment, for the example shown in Table 1-4 above, the determining unit 620 is configured to determine a radio frame number, SFN, and a start subframe number, a, for use by the base station for transmitting the other system information messages, such that:

a=x mode 10,

where x=(n−1)*w, where n denotes an order of the other system information messages in a list of the system information messages (schedulingInfoList), and w denotes a length of each system information window (si-WindowLength);

SFN mod M=floor (x/10),

where M denotes a length of the transmission cycle (si-transmissioncycle) and floor( ) denotes a flooring function.

The receiving unit 610 is configured to receive the other system information messages in accordance with the determined radio frame number, SFN, and start subframe number, a, and the time domain resources in each of the one or more system information windows that are used for the initial transmission and the one or more retransmissions of the other system information messages (si-timedomainresourcemapping and/or si-timedomainresourcemappingSlx), until the other system information messages have been correctly received or all of the system information windows (si-repetitionwindows system information windows) have been received.

In an embodiment, the transmission cycle includes a plurality of combination system information windows each for an initial transmission or retransmission of one or more of the other system information messages. The SIB1 message further includes: a combination window length indication indicating a length of each combination system information window; a time domain resource mapping indication indicating time domain resources in each combination system information window that are used for the initial transmission or retransmission of the one or more other system information messages, and a repetition number indication indicating a number of combination system information windows included in the transmission cycle. Alternatively, at least one of the length of each combination system information window, the time domain resources in each combination system information window that are used for the initial transmission or retransmission of the one or more other system information messages and the number of combination system information windows included in the transmission cycle is predetermined.

In an embodiment, the transmission of the system information to the MTC UE is independent from transmission of system information to a non−MTC UE.

For the example shown in Table 2-1 above, the determining unit 620 is configured to determine a radio frame number, SFN, and a start subframe number, b, for use by the base station for transmitting the plurality of combination system information windows, such that:

b=0,

SFN mod M=0,

where M denotes a length of the transmission cycle (si-transmissioncycle).

The receiving unit 610 is configured to receive the other system information messages in accordance with the determined radio frame number, SFN, and start subframe number, b, and the time domain resources in each combination system information window that are used for the initial transmission or retransmission of the one or more other system information messages (si-timedomainresourcemapping and/or si-timedomainresourcemappingSlx), until the other system information messages have been correctly received or all of the combination system information windows (repetitiontimes system information windows) have been received.

Further, for a non−MTC UE, the transmission of the system information starts from subframe #c, where c=x mod 10, and the SFN of the radio frame in which the subframe is included satisfies SFN mod T=FLOOR(x/10), where T is a system information period indicated by the parameter si-Periodicity in the SIB1 message.

In an embodiment, the initial transmission and the one or more retransmissions of the system information for the MTC UE may not occur within the system information window.

For the example shown in Table 3-1 above, the determining unit 620 is configured to determine a radio frame number, SFN, and a start subframe number, d, for use by the base station for transmitting the other system information messages, such that:

d=x mode10,

where x=(n−1)*w, where n denotes an order of the other system information messages in a list of the system information messages (schedulingInfoList), and w denotes a length of each system information window (si-WindowLength);

SFN mod M=floor (x/10),

where M denotes a length of the transmission cycle (si-transmissioncycle) and floor( ) denotes a flooring function.

The receiving unit 610 is configured to receive the other system information messages in accordance with the determined radio frame number, SFN, and start subframe number, d, and the time domain resources in one transmission cycle that are used for the initial transmission and the one or more retransmissions of the other system information messages (si-timedomainresourcemapping and/or si-timedomainresourcemappingSlx), until the other system information messages have been correctly received or the transmission cycle ends.

In an embodiment, the SIB1 message further includes: at least one of a Modulation and Coding Scheme (MCS) indication and a Transport Block Size (TBS) indication, the MCS indication indicating an MCS for the initial transmission and the one or more retransmissions of the other system information messages, and the TBS indication indicating a TBS for the initial transmission and the one or more retransmissions of the other system information messages, and a frequency domain indication indicating frequency domain resources for the initial transmission and the one or more retransmissions of the other system information messages. Alternatively, at least one of the MCS for the initial transmission and the one or more retransmissions of the other system information messages, the TBS for the initial transmission and the one or more retransmissions of the other system information messages and the frequency domain resources for the initial transmission and the one or more retransmissions of the other system information messages is predetermined.

FIG. 7 is a flowchart illustrating a method 700 in an MTC UE according to an embodiment of the present disclosure. It is to be noted here that all the features described above in connection with the embodiments of the UE 600 also apply to the method embodiments below. The method 700 can be performed by the above UE 600 and includes the following steps.

At step S710, a System Information Block Type 1 (SIB1) message is received from a base station.

At step S720, resources for use by the base station for transmitting other system information messages are determined. The transmission includes an initial transmission and one or more retransmissions.

At step S730, the other system information messages are received over the determined resources.

According to the present disclosure, the resources for the initial transmission and the one or more retransmissions of the other system information messages are indicated by the SIB1 message or predetermined.

In an embodiment, the SIB1 message includes a transmission cycle indication indicating a length of a transmission cycle in which the initial transmission and the one or more retransmissions of the other system information messages occur. Alternatively, the length of the transmission cycle is predetermined.

In an embodiment, the transmission cycle includes a plurality of system information windows, each of one or more of the plurality of system information windows is used for the initial transmission and the one or more retransmissions of the other system information messages. The SIB1 message further includes: a time domain resource mapping indication indicating time domain resources in each of the one or more system information windows that are used for the initial transmission and the one or more retransmissions of the other system information messages, and a window repetition indication indicating a position of each of the one or more system information windows in the transmission cycle. Alternatively, at least of the time domain resources in each of the one or more system information windows that are used for the initial transmission and the one or more retransmissions of the other system information messages and the position of each of the one or more system information windows in the transmission cycle is predetermined.

In an embodiment, the transmission of the system information to the MTC UE at least partly reuses resources for transmission of system information to a non−MTC UE.

In an embodiment, the step of determining resources for use by the base station for transmitting the other system information messages includes: determining a radio frame number, SFN, and a start subframe number, a, for use by the base station for transmitting the other system information messages, such that:

a=x mode 10,

where x=(n−1)*w, where n denotes an order of the other system information messages in a list of the system information messages, and w denotes a length of each system information window;

SFN mod M=floor (x/10),

where M denotes a length of the transmission cycle and floor( ) denotes a flooring function. The step of receiving the other system information messages over the determined resources includes: receiving the other system information messages in accordance with the determined radio frame number, SFN, and start subframe number, a, and the time domain resources in each of the one or more system information windows that are used for the initial transmission and the one or more retransmissions of the other system information messages, until the other system information messages have been correctly received or all of the system information windows have been received.

In an embodiment, the transmission cycle includes a plurality of combination system information windows each for an initial transmission or retransmission of one or more of the other system information messages. The SIB1 message further includes: a combination window length indication indicating a length of each combination system information window; a time domain resource mapping indication indicating time domain resources in each combination system information window that are used for the initial transmission or retransmission of the one or more other system information messages, and a repetition number indication indicating a number of combination system information windows included in the transmission cycle. Alternatively, at least one of the length of each combination system information window, the time domain resources in each combination system information window that are used for the initial transmission or retransmission of the one or more other system information messages and the number of combination system information windows included in the transmission cycle is predetermined.

In an embodiment, the transmission of the system information to the MTC UE is independent from transmission of system information to a non−MTC UE.

In an embodiment, the step of determining resources for use by the base station for transmitting the other system information messages includes: determining a radio frame number, SFN, and a start subframe number, b, for use by the base station for transmitting the plurality of combination system information windows, such that:

b=0,

SFN mod M=0,

where M denotes a length of the transmission cycle. The step of receiving the other system information messages over the determined resources includes: receiving the other system information messages in accordance with the determined radio frame number, SFN, and start subframe number, b, and the time domain resources in each combination system information window that are used for the initial transmission or retransmission of the one or more other system information messages, until the other system information messages have been correctly received or all of the combination system information windows have been received.

In an embodiment, the transmission cycle does not include a plurality of system information windows. One or more repeated transmissions of the system information do not occur within the system information window.

In an embodiment, the step of determining resources for use by the base station for transmitting the other system information messages includes: determining a radio frame number, SFN, and a start subframe number, d, for use by the base station for transmitting the other system information messages, such that:

d=x mode 10,

where x=(n−1)*w, where n denotes an order of the other system information messages in a list of the system information messages, and w denotes a length of each system information window;

SFN mod M=floor (x/10),

where M denotes a length of the transmission cycle (si-transmissioncycle) and floor( ) denotes a flooring function. The step of receiving the other system information messages over the determined resources includes: receiving the other system information messages in accordance with the determined radio frame number, SFN, and start subframe number, d, and the time domain resources in one transmission cycle that are used for the initial transmission and the one or more retransmissions of the other system information messages, until the other system information messages have been correctly received or the transmission cycle ends.

In an embodiment, the SIB1 message further includes: at least one of a Modulation and Coding Scheme (MCS) indication and a Transport Block Size (TBS) indication, the MCS indication indicating an MCS for the initial transmission and the one or more retransmissions of the other system information messages, and the TBS indication indicating a TBS for the initial transmission and the one or more retransmissions of the other system information messages, and a frequency domain indication indicating frequency domain resources for the initial transmission and the one or more retransmissions of the other system information messages. Alternatively, at least one of the MCS for the initial transmission and the one or more retransmissions of the other system information messages, the TBS for the initial transmission and the one or more retransmissions of the other system information messages and the frequency domain resources for the initial transmission and the one or more retransmissions of the other system information messages is predetermined.

The details described above in connection with the base station 100 also apply to the method 500, the MTC UE 600 and the method 700.

It can be appreciated that the above embodiments of the present disclosure can be implemented in software, hardware or any combination thereof. For example, the internal components of the base station and the UE in the above embodiments can be implemented using various devices including, but not limited to, analog circuit device, digital circuit device, Digital Signal Processing (DSP) circuit, programmable processor, Application Specific Integrated Circuit (ASIC), Field Programmable Gate Array (FPGA), Programmable Logic Device (CPLD) and the like.

In the present disclosure, the term “base station” means a mobile communication data and control exchange center with a large transmit power and a wide coverage area and including functions such as resource allocation/scheduling, data reception/transmission and the like. The term “user equipment” means a user mobile terminal, including e.g., a mobile phone, a notebook computer and other terminal devices that can wirelessly communicate with a base station or and micro base station.

Further, the embodiments of the present disclosure can be implemented in computer program products. More specifically, a computer program product can be a product having a computer readable medium with computer program logics coded thereon. When executed on a computing device, the computer program logics provide operations for implementing the above solutions according to the present disclosure. When executed on at least one processor in a computing system, the computer program logics cause the processor to perform the operations (methods) according to the embodiments of the present disclosure. This arrangement of the present disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules. The software, firmware or arrangement can be installed in a computing device to cause one or more processors in the computing device to perform the solutions according to the embodiments of the present disclosure.

The present disclosure has been described above with reference to the preferred embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached and the equivalents thereof.

1-32. (canceled)

33. A method in a base station, comprising:
determining resources for transmitting system information to a Machine Type Communication (MTC) User Equipment (UE), the system information comprising a System Information Block Type 1 (SIB1) message and other system information messages; and
transmitting the system information to the MTC UE over the determined resources, the transmission comprising an initial transmission and one or more retransmissions, wherein the resources for the initial transmission and the one or more retransmissions of the other system information messages are indicated by the SIB1 message or predetermined.

34. A base station, comprising:
a resource determining unit configured to determine resources for transmitting system information to a Machine Type Communication (MTC) User Equipment (UE), the system information comprising a System Information Block Type 1 (SIB1) message and other system information messages; and
a transmitting unit configured to transmit the system information to the MTC UE over the determined resources, the transmission comprising an initial transmission and one or more retransmissions, wherein the resources for the initial transmission and the one or more retransmissions of the other system information messages are indicated by the SIB1 message or predetermined.

35. The base station of claim 34, wherein the SIB1 message comprises a transmission cycle indication indicating a length of a transmission cycle in which the initial transmission and the one or more retransmissions of the other system information messages occur, or the length of the transmission cycle is predetermined.

36. The base station of claim 35, wherein the transmission cycle comprises a plurality of system information windows, and each of one or more of the plurality of system information windows is used for the initial transmission and the one or more retransmissions of the other system information messages, the SIB1 message further comprises:
a time domain resource mapping indication indicating time domain resources in each of the one or more system information windows that are used for the initial transmission and the one or more retransmissions of the other system information messages, and a window repetition indication indicating a position of each of the one or more system information windows in the transmission cycle, or at least of the time domain resources in each of the one or more system information windows that are used for the initial transmission and the one or more retransmissions of the other system information messages and the position of each of the one or more system information windows in the transmission cycle is predetermined.

37. The base station of claim 36, wherein the transmission of the system information to the MTC UE at least partly reuses resources for transmission of system information to a non-MTC UE.

38. The base station of claim 35, wherein the transmission cycle comprises a plurality of combination system information windows each for an initial transmission or retransmission of one or more of the other system information messages, the SIB1 message further comprises:
a combination window length indication indicating a length of each combination system information window;
a time domain resource mapping indication indicating time domain resources in each combination system information window that are used for the initial transmission or retransmission of the one or more other system information messages, and a repetition number indication indicating a number of combination system information windows included in the transmission cycle, or at least one of the length of each combination system information window, the time domain resources in each combination system information window that are used for the initial transmission or retransmission of the one or more other system information messages and the number of combination system information windows included in the transmission cycle is predetermined.

39. The base station of claim 38, wherein the transmission of the system information to the MTC UE is independent from transmission of system information to a non−MTC UE.

40. The base station of claim 34, wherein the SIB1 message further comprises:
at least one of a Modulation and Coding Scheme (MCS) indication and a Transport Block Size (TBS) indication, the MCS indication indicating an MCS for the initial transmission and the one or more retransmissions of the other system information messages, and the TBS indication indicating a TBS for the initial transmission and the one or more retransmissions of the other system information messages, and a frequency domain indication indicating frequency domain resources for the initial transmission and the one or more retransmissions of the other system information messages, or at least one of the MCS for the initial transmission and the one or more retransmissions of the other system information messages, the TBS for the initial transmission and the one or more retransmissions of the other system information messages and the frequency domain resources for the initial transmission and the one or more retransmissions of the other system information messages is predetermined.

41. A method in a Machine Type Communication (MTC) User Equipment (UE), comprising:
receiving a System Information Block Type 1 (SIB1) message from a base station;
determining resources for use by the base station for transmitting other system information messages, the transmission comprising an initial transmission and one or more retransmissions; and
receiving the other system information messages over the determined resources, wherein the resources for the initial transmission and the one or more retransmissions of the other system information messages are indicated by the SIB1 message or predetermined.

42. A Machine Type Communication (MTC) User Equipment (UE), comprising:
a receiving unit configured to receive a System Information Block Type 1 (SIB1) message from a base station; and
a determining unit configured to determine resources for use by the base station for transmitting other system information messages, the transmission comprising an initial transmission and one or more retransmissions, wherein the receiving unit is further configured to receive the other system information messages over the determined resources, wherein the resources for the initial transmission and the one or more retransmissions of the other system information messages are indicated by the SIB1 message or predetermined.

43. The MTC UE of claim 42, wherein the SIB1 message comprises a transmission cycle indication indicating a length of a transmission cycle in which the initial transmission and the one or more retransmissions of the other system information messages occur, or the length of the transmission cycle is predetermined.

44. The MTC UE of claim 43, wherein the transmission cycle comprises a plurality of system information windows, and each of one or more of the plurality of system information windows is used for the initial transmission and the one or more retransmissions of the other system information messages, the SIB1 message further comprises:
a time domain resource mapping indication indicating time domain resources in each of the one or more system information windows that are used for the initial transmission and the one or more retransmissions of the other system information messages, and a window repetition indication indicating a position of each of the one or more system information windows in the transmission cycle, or at least of the time domain resources in each of the one or more system information windows that are used for the initial transmission and the one or more retransmissions of the other system information messages and the position of each of the one or more system information windows in the transmission cycle is predetermined.

45. The MTC UE of claim 44, wherein the transmission of the system information to the MTC UE at least partly reuses resources for transmission of system information to a non-MTC UE.

46. The MTC UE of claim 44, wherein the determining unit is configured to determine a radio frame number, SFN, and a start subframe number, a, for use by the base station for transmitting the other system information messages, such that:
a=x mode 10, where x=(n−1)*w, where n denotes an order of the other system information messages in a list of the system information messages, and w denotes a length of each system information window;
SFN mod M=floor (x/10), where M denotes a length of the transmission cycle and floor( ) denotes a flooring function, and the receiving unit is configured to receive the other system information messages in accordance with the determined radio frame number, SFN, and start subframe number, a, and the time domain resources in each of the one or more system information windows that are used for the initial transmission and the one or more retransmissions of the other system information messages, until the other system information messages have been correctly received or all of the system information windows have been received.

47. The MTC UE of claim 42, wherein the transmission cycle comprises a plurality of combination system information windows each for an initial transmission or retransmission of one or more of the other system information messages, the SIB1 message further comprises:
a combination window length indication indicating a length of each combination system information window;
a time domain resource mapping indication indicating time domain resources in each combination system information window that are used for the initial transmission or retransmission of the one or more other system information messages, and a repetition number indication indicating a number of combination system information windows included in the transmission cycle, or at least one of the length of each combination system information window, the time domain resources in each combination system information window that are used for the initial transmission or retransmission of the one or more other system information messages and the number of combination system information windows included in the transmission cycle is predetermined.

48. The MTC UE of claim 47, wherein the transmission of the system information to the MTC UE is independent from transmission of system information to a non−MTC UE.

49. The MTC UE of claim 47, wherein the determining unit is configured to determine a radio frame number, SFN, and a start subframe number, b, for use by the base station for transmitting the plurality of combination system information windows, such that:
b=0, SFN mod M=0, where M denotes a length of the transmission cycle, and the receiving unit is configured to receive the other system information messages in accordance with the determined radio frame number, SFN, and start subframe number, b, and the time domain resources in each combination system information window that are used for the initial transmission or retransmission of the one or more other system information messages, until the other system information messages have been correctly received or all of the combination system information windows have been received.

50. The MTC UE of claim 42, wherein the SIB1 message further comprises:
at least one of a Modulation and Coding Scheme (MCS) indication and a Transport Block Size (TBS) indication, the MCS indication indicating an MCS for the initial transmission and the one or more retransmissions of the other system information messages, and the TBS indication indicating a TBS for the initial transmission and the one or more retransmissions of the other system information messages, and a frequency domain indication indicating frequency domain resources for the initial transmission and the one or more retransmissions of the other system information messages, or at least one of the MCS for the initial transmission and the one or more retransmissions of the other system information messages, the TBS for the initial transmission and the one or more retransmissions of the other system information messages and the frequency domain resources for the initial transmission and the one or more retransmissions of the other system information messages is predetermined.
